(19) United States
(12) Patent Application Publication
(10) Pub. No.: US 2023/0169233 A1
(43) Pub. Date: Jun. 1, 2023

(54) HEATSINK CONFIGURATION GENERATION

(71) Applicant: Siemens Industry Software Inc., Plano, TX (US)

(72) Inventors: Robin Bornoff, Herefordshire (GB); John Parry, Surrey (GB); Matthew Warner, Teddington (GB)

(21) Appl. No.: 17/922,016

(22) PCT Filed: Apr. 28, 2020
(86) PCT No.: PCT/US2020/030186

§ 371 Date: Oct. 28, 2022

(51) Int. Cl. G06F 30/20

(52) U.S. Cl. CPC G06F 30/20

(57) ABSTRACT

A method, executed by at least one processor of a computer, of generating a heatsink configuration meeting a predetermined performance constraint is disclosed. The method includes establishing an initial heatsink configuration having a heatsink base including at least one layer formed of a plurality of tessellated rods and setting a thermal evaluation parameter. An initial thermal simulation of a heat source positioned proximate the heatsink base is performed to determine the initial thermal performance of the heatsink. Based on the initial thermal simulation, three revised heatsink configurations are examined, and simulations are carried out to generate first, second, and third revised thermal performances. These are compared with an initial thermal performance, and the heatsink configuration showing the greatest improvement in thermal performance compared with the initial thermal performance is selected. This process is repeated until a heatsink configuration meeting the predetermined performance constraint is generated.

This application is the National Stage of International Application No. PCT/US2020/030186, filed Apr. 28, 2020. The entire contents of this document are hereby incorporated herein by reference.

### BACKGROUND

The present embodiments relate to generating a heatsink configuration meeting a predetermined performance constraint.

A heatsink is a passive heat exchanger that transfers heat generated by a device to a fluid medium where the heat is dissipated, thus regulating the device temperature. Common electronic devices utilizing heatsinks include central processing units (CPUs), graphics processing units (GPUs), random access memory (RAM) modules, chipsets, transistors, lasers, and light emitting diodes (LEDs), where the cooling fluid is often air. Mechanical devices and operations may also employ heatsinks, such as soldering. Typical heatsink designs include a plurality of individual fins aligned on a base to encourage convection, either natural, where fluid movement is due to heat transfer, or forced, where fluid movement is due to external forces, such as a fan. Standard methods of heatsink design involve an a priori assumption of the parameterizable topology of the heatsink: the heat sink has a base and plate fins, and each fin has specified dimensions, as illustrated in FIG. 1.

FIG. 1 is a perspective schematic representation of a basic prior art heatsink design. The heatsink 1 includes a heatsink base 2 on which a plurality of elongate fins 3 are provided. These elongate fins 3 have a depth d, a width w, and a height h, and extend across the base 2 having length l, and are separated by a gap distance g. Other designs of heatsink may employ rods/pins or elliptical fins in place of the elliptical fins of FIG. 1. Various optimization techniques may be applied to identify the set of topology parameters that result in the best thermal performance of the heatsink, such as those described in Simulation-Based Design optimization methodologies Applied to CFD, Parry et al, IEEE Transactions on Components and Packaging Technologies 27(2): 391-297, July 2004. One drawback with using such methods, however, is that the only heatsink geometries that will be identified will conform to the assumed topology.

Topology optimization (TO) is an emerging technology for industrial applications that seeks to identify geometric forms that are not constrained by any assumed part topology. The most common topology optimization approach is known as Solid Isotropic Material with Penalization (SIMP) and is used most often in structure applications involving quantification of stress and strain. A greyscale prediction of material properties of the application are iteratively predicted so as to converge to a geometric form that is most efficient. The greyscale distribution is then partitioned into black and white regions that constitute the final topology optimized geometry. This process involves a primal 3D simulation of the greyscale problem definition, and additional adjoint solution to determine the sensitivity to changes of the primal solution to a parameter of interest (e.g., a cost function to be minimized or maximized) and an optimizer used to guide the process to an optimum topology.

Both additive and subtractive techniques have been proposed to optimize heatsink designs. U.S. Pat. No. 9,928,317 proposes the use of an additive design process, where the heat sink fins were allowed to grow where the surface temperature was the highest, as part of an iterative design process. The heat sink topology evolved over a number of cycles until no further performance gains were achieved. US2017/0091356 proposes a subtractive design, based on mass removal, where thermal property value of a portion of the heat sink design relates to the contribution of the portion to thermal performance of the heat sink design; one or more portions of the heat sink design are removed to generate a new heat sink design. One or more portions of the heat sink design are selected based on the thermal property values and contribute less to the thermal performance of the heat sink design than remaining portions of the heat sink design eligible to be removed.

Even optimized designs, however, suffer from a tendency to conform to or be constrained by commonly assumed heatsink shapes or forms. This therefore limits the efficiency of heatsinks in certain applications and prevents full optimization of heatsink designs. There therefore exists a need to be able to identify novel heatsink forms that are not constrained by and lack conformity to commonly assumed heatsink forms.

### SUMMARY AND DESCRIPTION

The scope of the present invention is defined solely by the appended claims and is not affected to any degree by the statements within this summary.

In a first aspect, a method, executed by at least one processor of a computer, of generating a heatsink configuration meeting a pre-determined performance constraint includes: a) establishing an initial heatsink configuration having a heatsink base including at least one layer formed of a plurality of tessellated rods and setting a thermal evaluation parameter; b) performing an initial thermal simulation of a heat source positioned proximate the heatsink base to determine the initial thermal performance of the heatsink; c) selecting, based on the initial thermal simulation, a first rod that has a lowest value of the thermal evaluation parameter and a second rod that has a highest value of the thermal evaluation parameter and i) generating a first revised heatsink configuration by removing the first rod from the heatsink base and carrying out a first subsequent thermal simulation to determine a first revised thermal performance; ii) generating a second revised heatsink configuration by adding a third rod to the heatsink base positioned on the second rod and carrying out a second subsequent thermal simulation to determine a second revised thermal performance; and iii) generating a third revised heatsink configuration by removing the first rod from the heatsink base and adding the third rod to the heatsink base positioned on the second rod and carrying out a third subsequent thermal simulation to determine a third revised thermal performance; iv) comparing the first, second, and third revised thermal performances to the initial thermal performance and electing the heatsink configuration that results in a greatest improvement in thermal performance from the initial thermal performance; and d) using the elected heatsink configuration in place of the initial heatsink configuration, repeating act c) above until a final heatsink configuration meeting the predetermined performance constraint is generated.

Advantages of the present embodiments include that unlike prior art approaches of assuming a parameterized topological definition of a heatsink, users are offered the ability to identify highly non-standard, non-parameterizable heatsink geometries using parameters generated by a primal simulation on a geometry that accurately reflects a heatsink capable of being fabricated easily using known techniques.

In one embodiment, if the first, second, and third revised thermal performances show no improvement in thermal performance compared to an initial or an elected heatsink configuration, a fourth rod that has a second lowest value of the thermal evaluation parameter and a fifth rod that has a second highest value of the thermal evaluation parameter are selected, and act c) is repeated.

In one embodiment, the thermal evaluation parameter is a bottle neck heat transfer characteristic value, a shortcut heat transfer characteristic value, a temperature, or a heat flux.

In one embodiment, the pre-determined performance constraint is a maximum heatsink temperature or a heatsink design volume.

In one embodiment, a rod is a tessellating body having at least four surfaces. In one embodiment, a rod is a cuboid having six surfaces. At least one surface of the second rod may be in contact with another rod in any heatsink configuration. The third rod may be added to a surface of the second rod that is not in contact with another rod. In one embodiment, the surface the third rod is added to is chosen based on temperature or convective heat transfer co-efficient.

In one embodiment, each of the rods is the same physically and/or thermally.

In one embodiment, the at least one layer of tessellated rods represents an existing heatsink geometry.

In a second aspect, the present embodiments also provides a non-transitory computer readable media storing computer-executable instructions that, when executed on one or more processors, perform the method laid out above. In a third aspect, the present embodiments provide a system including one or more processors programmed to perform the method laid out above.

### BRIEF DESCRIPTION OF THE DRAWINGS

FIG. 1 is a perspective schematic representation of a basic prior art heatsink design;

FIG. 2 is a perspective schematic representation of a heatsink base that includes a plurality of tessellated rods in accordance with an embodiment

FIG. 3 is a schematic diagram of a front view of the heatsink of FIG. 2 showing thermal bottlenecks;

FIG. 4a is a schematic diagram illustrating a heatsink with one tessellated rod removed;

FIG. 4b is a schematic diagram illustrating a heatsink with one tessellated rod added;

FIG. 4c is a schematic diagram illustrating a heatsink with one tessellated rod removed and one tessellated rod added; and

FIG. 5 is a schematic diagram illustrating an optimized heatsink design generated using a method in accordance with an embodiment.

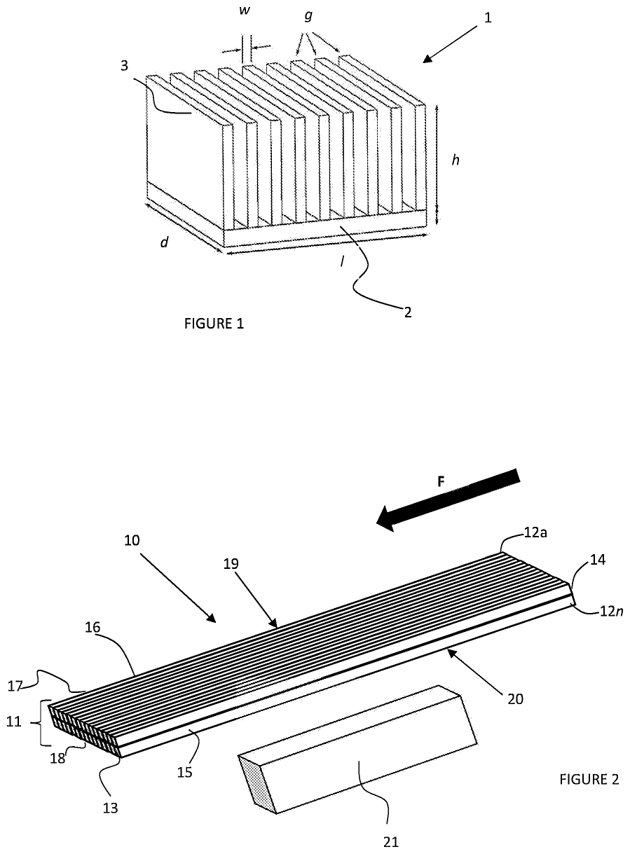

### DETAILED DESCRIPTION

Combining the benefits of an additive method and a subtractive method of generating a heatsink removes the need for a parameterized topological definition and the use of an adjoint solution or optimizer; instead, such combining enables the physical geometry without the need for a greyscale definition. The approach of one or more of the present embodiments is to use a method, executed by at least one processor of a computer, of generating a heatsink configuration meeting a pre-determined performance constraint. The method includes a number of acts, starting with establishing an initial heatsink configuration having a heatsink base including at least one layer formed of a plurality of tessellated rods and setting a thermal evaluation parameter. Then, an initial thermal simulation of a heat source positioned proximate to the heatsink base is performed to determine the initial thermal performance of the heatsink. A first rod having a lowest value of the thermal evaluation parameter and a second rod that has a highest value of the thermal evaluation parameter are selected based on the initial thermal simulation. At this point, a first revised heatsink configuration is generated by removing the first rod from the heatsink base is generated and carrying out a first subsequent thermal simulation to determine a first revised thermal performance (e.g., a subtractive approach). A second revised heatsink configuration is then generated by adding a third rod to the heatsink base positioned on the second rod and carrying out a second sub-sequent thermal simulation to determine a second revised thermal performance (e.g., an additive approach). Finally, a third revised heatsink configuration is generated by removing the first rod from the heatsink base and adding the third rod to the heatsink base positioned on the second rod and carrying out a third subsequent thermal simulation to determine a third revised thermal performance (e.g., the combined approach). The next act is to compare the first revised thermal performance, the second revised thermal performance, and the third revised thermal performance to the initial thermal performance and electing the heatsink configuration that results in the greatest improvement in thermal performance from the initial thermal performance. The elected heatsink configuration is then used in place of the initial heatsink configuration as a basis for carrying out the acts of generating the heatsink configurations and selecting the heatsink configuration with the greatest performance improvement until a final heatsink configuration meeting the pre-determined performance constraint is generated.

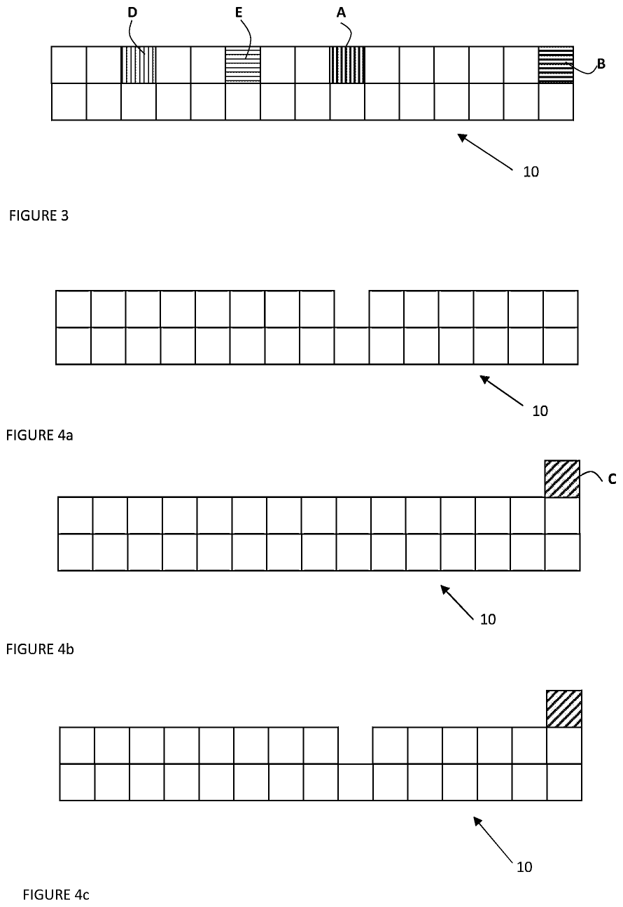

FIG. 2 is a perspective schematic representation of a heatsink base that includes a plurality of tessellated rods in accordance with a first embodiment. The heatsink 10 includes a base 11 formed from a plurality of tessellated rods 12a, b, c . . . n. Each rod of the plurality of tessellated rods 12a, b, c . . . n is a cuboid having a first square face 13, a second square face 14 opposite the first square face 13, and joined by four elongate rectangular faces 15, 16, 17, 18. In the design shown, the tessellated rods 12 are arranged in two rows 19, 20 of fifteen rods stacked such that the square faces 13, 14 form a rectangular wall with each rod 12 in the first row 19 in registration with a rod 12 in the second row 20. This is illustrated clearly in FIG. 3, which is a schematic diagram of the front view of the heatsink based on FIG. 2 showing thermal bottlenecks. The front view shows the first square faces 13 of each rod stacked in registration in two rows 19, 20 of fifteen rods 12. In order to determine which rods should be impacted by the heatsink generation process, a thermal parameter is chosen to enable a direct comparison between the rods. In the embodiment shown in FIG. 3, the thermal parameter chosen is the bottleneck heat transfer characteristic value, but other parameters, such as, for example, shortcut heat transfer characteristic value, temperature, or heat flux, may be chosen instead. The bottleneck heat transfer characteristic is a non-dimensionalized dot product of the heat flux and temperature gradient vectors at a given location. The shortcut heat transfer characteristic is a non-dimensionalized magnitude of the cross product of the heat flux and the temperature gradient vectors at a given location.

In addition, a pre-determined performance constraint is selected for the heatsink configuration. This may, for example, be the reduction of the maximum heatsink temperature to a desired value or the filling of a specified design volume for the finalized heatsink. In this embodiment, the reduction of maximum heatsink temperature is used. Once the thermal evaluation parameter has been chosen, an initial thermal simulation of a heat source 21 positioned proximate the heatsink base 11 is carried out to determine the initial thermal performance of the heatsink 10. Based on the performance constraint, the thermal performance of the heatsink 10 is based on temperature, with the key performance indicator being the maximum heatsink temperature. The heat source 21 is placed underneath the heatsink base 11, with the region above the heatsink base 11 being subject to fluid flow in a direction parallel to the heatsink base 11, as indicated by arrow F. As a result of this initial thermal simulation, it is possible to select a first rod A that has the lowest value of the thermal evaluation parameter and a second rod B that has the highest value of the thermal evaluation parameter. Turning to FIG. 3, the rod A having the smallest thermal bottleneck value is marked with vertical hatching. The rod B having the largest thermal bottleneck value is marked with horizontal hatching. Once these rods A, B have been identified, there are three possible scenarios for determining the next layer of the heatsink 10: subtraction, addition, or combination.

FIG. 4a is a schematic diagram illustrating a heatsink with one tessellated rod removed. This represents the generation of a first revised heatsink 10a configuration by the removal of the tessellated rod A shown in FIG. 3 with the lowest thermal bottleneck value. Once this has been done, a first subsequent thermal simulation is carried out to determine a first revised thermal performance. FIG. 4b is a schematic diagram illustrating a heatsink with one tessellated rod added. This represents the generation of a second revised heatsink 10b configuration by the addition of a tessellated rod C to the rod B shown in FIG. 3 to have the highest thermal bottleneck value. The rod C is shown with cross hatching in FIG. 4b. Once this has been done, a second subsequent thermal simulation is carried out to determine a second revised thermal performance. Finally, FIG. 4c is a schematic diagram illustrating a heatsink with one tessellated rod removed and one tessellated rod added. This represents the generation of a third revised heatsink 10c configuration by the removal of a tessellated rod A from the heatsink base 10 and the addition of a tessellated rod C shown in FIG. 3 to have the highest thermal bottleneck value. The rod C is also shown with cross hatching in FIG. 4c. Once this has been done, a third subsequent thermal simulation is carried out to determine a third revised thermal performance. The addition and removal of rods 2 results in a change in fluid flow around the heatsink configuration in a manner that enables the optimal thermal performance to be determined.

At this point, the first revised thermal performance, the second revised thermal performance, and the third revised thermal performance are compared with the initial thermal performance of the heatsink 10. In this embodiment, the greatest improvement in thermal performance is indicated by the greatest reduction in the maximum heatsink 10 temperature. The heatsink configuration 10a, b, c that results in the greatest improvement in thermal performance and therefore lowest value of maximum heatsink temperature compared with the initial thermal performance is then elected and replaces the initial heatsink configuration 10. The remaining heatsink configurations 10a, b are discarded. Based on the thermal performance of the selected heatsink configuration 10c, the three thermal simulations illustrated in FIGS. 4a, 4b and 4c are carried out again to determine where rods 12 should be removed and added to the revised heatsink configuration. This process is continued until the chosen performance constraint is reached. However, if in an act, none of the first, second, or third revised heatsink configurations 10 show improvement in thermal performance, then a fourth rod D having the second lowest value of the thermal evaluation parameter and a fifth rod E having the second highest thermal evaluation parameter may be selected, and the simulations illustrated in FIGS. 4a, 4b and 4c may be carried out. This causes the heatsink 10 to grow and morph by the addition and subtraction of abutting rods until a desired heatsink configuration 10 is reached.

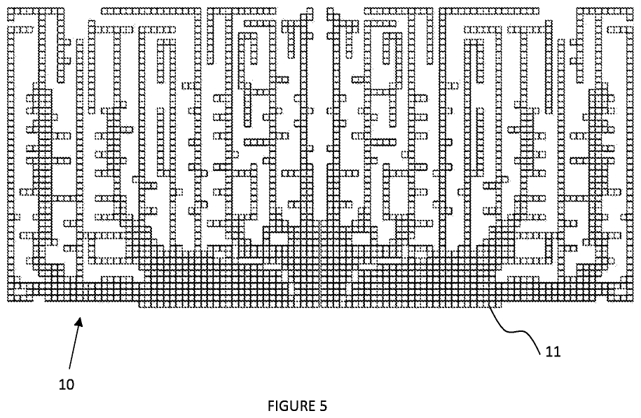

An example of this is shown in FIG. 5, which is a schematic diagram illustrating an optimized heatsink design generated using a method in accordance with a first embodiment. This illustration shows the end view of the heatsink configuration 100, with the fluid flow direction being out of the page and parallel with the heatsink base 11. FIG. 5 shows that the width of the heatsink configuration 100 has been extended from the original heatsink base 11. This is because when adding a rod 12 there is no limitation that the rod 12 must be added to the horizontal face 13 of the rod remote from the heatsink base 11. In any heatsink 10 configuration, a rod 12 will have at least one surface in contact with the surface of another rod 12. The new additional rod 12 may be placed in contact with any surface of the rod 12 that is not in contact with another rod (e.g., a vertical face 14 of the rod 12), hence causing the heatsink configuration 10 to grow horizontally parallel to the heatsink base 11, rather than vertically away from the heatsink base 11. The face of the rod 12 chosen to receive the additional rod 12 may be based on the lowest temperature or the largest convective heat transfer coefficient.

In the above embodiment, the rods 12 are cuboidal in shape, having six faces. Other rod forms (e.g., having at least four faces, such as square-based pyramids) may, however, be used. In one embodiment, each rod is the same thermally and physically. There may, however, be situations where it is desirable for either the rod 12 shape, volume, number of faces, or size to vary within a heatsink configuration 10, 100, or for rods 12 in the same of different layers to have different thermal properties.

Unlike prior art approaches of assuming a parameterized topological definition of a heatsink, the present embodiments offer the ability to identify highly non-standard, non-parameterizable heatsink geometries. The freedom to be able to morph the heatsink configuration freely without the constraints created in parameterizable systems results in the ability to identify globally optimal, thermally efficient heatsink configurations. The advantage of using a thermal parameter such as bottleneck heat transfer characteristic, shortcut heat transfer characteristic, temperature, or heat flux is that the indicator of where heatsink geometry should be adapted is physics-based, and not reliant on an adjoint solution or optimizer. Such thermal parameters are generated from the primal simulation solution and therefore a result of the simulation process itself. In addition, the actual physical geometry of the heatsink is considered, not a greyscale solution that is to subsequently be partitioned into white (e.g., non-existing) and black (e.g., existing) regions to reconstruct the physical geometry of the heatsink. By controlling the size of the rods as well as direction of addition or removal of the rods, it becomes easier to apply manufacturing constraints to the physical geometry of the heatsink configuration, such as those required for milling, casting, or extruding, unlike with prior art topology optimization systems. Embodiments also offer the ability for existing thermal modelling software to generate improved heatsink designs by being included in backed computational fluid dynamics capabilities.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method, executed by at least one processor of a computer, of generating a heatsink configuration of a heatsink meeting a predetermined performance constraint, the method comprising:
establishing an initial heatsink configuration having a heatsink base comprising at least one layer formed of a plurality of tessellated rods and setting a thermal evaluation parameter;
determining an initial thermal performance of the heatsink, the determining of the initial thermal performance of the heatsink comprising performing an initial thermal simulation of a heat source positioned proximate the heatsink base;
selecting, based on the initial thermal simulation, a first rod that has a lowest value of the thermal evaluation parameter and a second rod that has a highest value of the thermal evaluation parameter;
generating a first revised heatsink configuration, the generating of the first revised heatsink configuration comprising removing the first rod from the heatsink base and carrying out a first subsequent thermal simulation, such that a first revised thermal performance is determined;
generating a second revised heatsink configuration, the generating of the second revised heatsink configuration comprising adding a third rod to the heatsink base positioned on the second rod and carrying out a second subsequent thermal simulation, such that a second revised thermal performance is determined;
generating a third revised heatsink configuration, the generating of the third revised heatsink configuration comprising removing the first rod from the heatsink base, adding the third rod to the heatsink base positioned on the second rod, and carrying out a third subsequent thermal simulation, such that a third revised thermal performance is determined;
comparing the first revised thermal performance, the second revised thermal performance, and the third revised thermal performance to the initial thermal performance and selecting the heatsink configuration that results in a greatest improvement in thermal performance from the initial thermal performance;
using the elected heatsink configuration in place of the initial heatsink configuration; and
repeating the selecting of the first rod and the selecting of the second rod until a final heatsink configuration meeting the predetermined performance constraint is generated.

2. The method of claim 1, further comprising selecting a fourth rod that has a second lowest value of the thermal evaluation parameter and a fifth rod that has a second highest value of the thermal evaluation parameter and repeating the selecting of the first rod and the selecting of the second rod when the first revised thermal performance, the second revised thermal performance, and the third revised thermal performance show no improvement in thermal performance compared to the initial heatsink configuration or the elected heatsink configuration.

3. The method of claim 1, wherein the thermal evaluation parameter is a bottle neck heat transfer characteristic value, a shortcut heat transfer characteristic value, a temperature, or a heat flux.

4. The method of claim 1, wherein the predetermined performance constraint is a maximum heatsink temperature or a heatsink design volume.

5. The method of claim 1, wherein a rod of the first rod, the second rod, and the third rod is a tessellating body having at least four surfaces.

6. The method of claim 5, wherein a rod of the first rod, the second rod, and the third rod is a cuboid having six surfaces.

7. The method of claim 4, wherein at least one surface of the second rod is in contact with another rod in any heatsink configuration.

8. The method of claim 7, wherein the third rod is added to a surface of the second rod that is not in contact with another rod.

9. The method of claim 8, wherein the surface the third rod is added to is chosen based on a temperature or a convective heat transfer coefficient.

10. The method of claim 1, wherein each of the first rod, the second rod, and the third rod is identical physically, thermally, or physically and thermally.

11. The method of claim 1, wherein the at least one layer of tessellated rods represents an existing heatsink geometry.

12. A non-transitory computer readable media storing computer-executable instructions that, when executed on one or more processors, generate a heatsink configuration of a heatsink meeting a predetermined performance constraint, the computer-executable instructions comprising:
establishing an initial heatsink configuration having a heatsink base comprising at least one layer formed of a plurality of tessellated rods and setting a thermal evaluation parameter;
determining an initial thermal performance of the heatsink, the determining of the initial thermal performance of the heatsink comprising performing an initial thermal simulation of a heat source positioned proximate the heatsink base;
selecting, based on the initial thermal simulation, a first rod that has a lowest value of the thermal evaluation parameter and a second rod that has a highest value of the thermal evaluation parameter;
generating a first revised heatsink configuration, the generating of the first revised heatsink configuration comprising removing the first rod from the heatsink base and carrying out a first subsequent thermal simulation, such that a first revised thermal performance is determined;
generating a second revised heatsink configuration, the generating of the second revised heatsink configuration comprising adding a third rod to the heatsink base positioned on the second rod and carrying out a second subsequent thermal simulation, such that a second revised thermal performance is determined;
generating a third revised heatsink configuration, the generating of the third revised heatsink configuration comprising removing the first rod from the heatsink base, adding the third rod to the heatsink base positioned on the second rod, and carrying out a third subsequent thermal simulation, such that a third revised thermal performance is determined;
comparing the first revised thermal performance, the second revised thermal performance, and the third revised thermal performance to the initial thermal performance and selecting the heatsink configuration that results in a greatest improvement in thermal performance from the initial thermal performance;
using the elected heatsink configuration in place of the initial heatsink configuration; and
repeating the selecting of the first rod and the selecting of the second rod until a final heatsink configuration meeting the predetermined performance constraint is generated.

13. A system comprising:
one or more processors configured to generate a heatsink configuration of a heatsink meeting a predetermined performance constraint, the generation of the heatsink configuration comprising:
establishment of an initial heatsink configuration having a heatsink base comprising at least one layer formed of a plurality of tessellated rods and setting a thermal evaluation parameter;
determination of an initial thermal performance of the heatsink, the determination of the initial thermal performance of the heatsink comprising performance of an initial thermal simulation of a heat source positioned proximate the heatsink base;
selection of, based on the initial thermal simulation, a first rod that has a lowest value of the thermal evaluation parameter and a second rod that has a highest value of the thermal evaluation parameter;
generation of a first revised heatsink configuration, the generation of the first revised heatsink configuration comprising removal of the first rod from the heatsink base and carrying out a first subsequent thermal simulation, such that a first revised thermal performance is determined;
generation of a second revised heatsink configuration, the generation of the second revised heatsink configuration comprising addition of a third rod to the heatsink base positioned on the second rod and carrying out a second subsequent thermal simulation, such that a second revised thermal performance is determined;
generation of a third revised heatsink configuration, the generation of the third revised heatsink configuration comprising removal of the first rod from the heatsink base, addition of the third rod to the heatsink base positioned on the second rod, and carrying out a third subsequent thermal simulation, such that a third revised thermal performance is determined;
comparison of the first revised thermal performance, the second revised thermal performance, and the third revised thermal performance to the initial thermal performance and selection of the heatsink configuration that results in a greatest improvement in thermal performance from the initial thermal performance;
use of the elected heatsink configuration in place of the initial heatsink configuration; and
repetition of the selection of the first rod and the selection of the second rod until a final heatsink configuration meeting the predetermined performance constraint is generated.

14. The non-transitory computer readable media of claim 12, wherein the computer-executable instructions further comprise selecting a fourth rod that has a second lowest value of the thermal evaluation parameter and a fifth rod that has a second highest value of the thermal evaluation parameter and repeating the selecting of the first rod and the selecting of the second rod when the first revised thermal performance, the second revised thermal performance, and the third revised thermal performance show no improvement in thermal performance compared to the initial heatsink configuration or the elected heatsink configuration.

15. The non-transitory computer readable media of claim 12, wherein the thermal evaluation parameter is a bottle neck heat transfer characteristic value, a shortcut heat transfer characteristic value, a temperature, or a heat flux.

16. The non-transitory computer readable media of claim 12, wherein the predetermined performance constraint is a maximum heatsink temperature or a heatsink design volume.

17. The non-transitory computer readable media of claim 12, wherein a rod of the first rod, the second rod, and the third rod is a tessellating body having at least four surfaces.

18. The non-transitory computer readable media of claim 17, wherein a rod of the first rod, the second rod, and the third rod is a cuboid having six surfaces.
